(19) United States
(12) Patent Application Publication
(10) Pub. No.: US 2026/0039583 A1
(43) Pub. Date: Feb. 5, 2026

(54) Latency Aware Routing

(71) Applicant: Cisco Technology, Inc., San Jose, CA (US)

(72) Inventors: Tapraj Singh, San Ramon, CA (US); Sunesh Rustagi, San Jose, CA (US); Praveen Bhagwatula, Cary, NC (US); Prashanth Buddhala, San Ramon, CA (US); Vijay Krishnaji Tapaskar, Palo Alto, CA (US)

(21) Appl. No.: 18/793,702

(22) Filed: Aug. 2, 2024

(51) Int. Cl. H04L 45/12; H04L 45/00; H04L 47/125

(52) U.S. Cl. CPC H04L 45/123; H04L 45/54; H04L 47/125

(57) ABSTRACT

Existing network architectures may experience latency variabilities due to varied cable lengths and diverse network paths available in a network fabric. Therefore, devices, systems, methods, and processes for facilitating enhanced latency-aware routing are described herein. A routing logic in a network fabric classifies two or more network paths, coupling a first network device to a second network device, into a plurality of groups based on latency attributes of the network paths. The routing logic in response to receiving a traffic flow at the first network device for the second network device, selects from the plurality of groups, a target group and routes the traffic flow to the second network device via at least one network path in the target group. If the target group includes more than one network path, the routing logic executes load balancing among a set of network paths classified into the target group.

The present disclosure relates to communication networks. More particularly, the present disclosure relates to latency aware routing in a network.

### BACKGROUND

The rapid evolution of data center demands has necessitated innovative networking solutions that can efficiently handle increased traffic and provide scalable, high-performance connectivity. Disaggregated scheduled fabric (DSF) topology has emerged as a leading solution, offering superior scalability, reduced latency, and simplified network management. DSF is a spine-leaf topology built on a fat-free network architecture, providing load balancing and congestion control for networks with intelligent traffic patterns, such as those found in Artificial Intelligence (AI) and Machine Learning (ML) workflows.

The DSF topology leverages disaggregated components including spine switches, leaf switches, and interconnecting cables of either fixed or varied lengths. The spine switches function as fabric devices, while the leaf switches form the network's edge. The leaf switches may be interconnected through the spine switches, with no direct leaf-to-leaf connectivity. Thus, all traffic between the leaf switches is routed through the spine switches, which primarily serve as interconnects between the leaf switches without routing protocols.

Despite the various improvements offered by the DSF topology, it still has notable limitations. For example, in DSF topology, the connection between the spine switches and the leaf switches can be established using cables of fixed or varied length, introducing variability in network performance. For example, latency inconsistencies can arise in the network due to varied cable lengths and different paths that data may traverse from one leaf switch to another. Even with uniform cable lengths, inherent differences in these paths can lead to latency discrepancies, which can be detrimental to latency-sensitive workloads.

### SUMMARY OF THE DISCLOSURE

Systems and methods for facilitating latency aware routing in a network in accordance with embodiments of the disclosure are described herein. In many embodiments, a device including a processor, a transceiver, and a memory communicatively coupled to the processor, is provided. The device is coupled to a network device via two or more network paths and each network path of the two or more network paths is associated with a latency attribute. The memory includes a routing logic that is configured to classify the two or more network paths into a plurality of groups based on the latency attribute of each of the two or more network paths, receive a traffic flow for the network device, select from the plurality of groups, a target group in response to receiving the traffic flow, and route the traffic flow to the network device via the selected target group.

In a number of embodiments, the plurality of groups includes at least a low latency group and a high latency group.

In a variety of embodiments, the low latency group has lower transmission latency than the high latency group.

In more embodiments, the plurality of groups further includes a medium latency group.

In yet more embodiments, the medium latency group has lower transmission latency than the high latency group and higher transmission latency than the low latency group.

In still more embodiments, each group of the plurality of groups is associated with a latency threshold range.

In still yet more embodiments, to classify the two or more network paths into the plurality of groups, the routing logic is further configured to compare the latency attribute of each of the two or more network paths with the latency threshold range of each of the plurality of groups. The routing logic classifies a network path of the two or more network paths into one of the plurality of groups that is associated with the latency threshold range encompassing the latency attribute of the network path.

In further embodiments, the traffic flow is associated with a service parameter.

In additional embodiments, the routing logic selects, from the plurality of groups, the target group that satisfies the service parameter.

In many further embodiments, the service parameter is configured to indicate a latency requirement associated with the traffic flow.

In further additional embodiments, the routing logic is further configured to maintain a routing table comprising the plurality of groups, each group of the plurality of groups being mapped to a corresponding latency threshold range in the routing table.

In many additional embodiments, the routing logic is further configured to look up in the routing table based on the service parameter. The routing logic selects from the plurality of groups, the target group having the corresponding latency threshold range that satisfies the service parameter

In numerous embodiments, each of the plurality of groups includes a set of network paths, of the two or more network paths, classified into corresponding group.

In several embodiments, to route the traffic flow via the target group, the routing logic is further configured to execute load balancing among the set of network paths classified into the target group.

In numerous additional embodiments, the device is a leaf switch in a disaggregated scheduled fabric.

In several additional embodiments, the traffic flow is associated with an Artificial Intelligence/Machine Learning workflow.

In still additional embodiments, prior to classifying the two or more network paths, the routing logic is further configured to determine the latency attribute associated with each of the two or more network paths.

In several more embodiments, a device including a processor, a transceiver, and a memory communicatively coupled to the processor, is provided. The device is coupled to a network device via two or more network paths and each network path of the two or more network paths is associated with one or more service attributes. The memory includes a routing logic that is configured to classify the two or more network paths into a plurality of groups based on at least one of the one or more service attributes, receive a traffic flow for the network device, select from the plurality of groups, a target group in response to receiving the traffic flow, and route the traffic flow to the network device via the selected target group.

In still yet further embodiments, prior to classifying the two or more network paths, the routing logic is further configured to determine the one or more service attributes associated with each of the two or more network paths.

In still yet additional embodiments, a method includes classifying two or more network paths into a plurality of groups based on a latency attribute associated with each of the two or more network paths. A first network device and a second network device are communicatively coupled via the two or more network paths. The method further includes receiving a traffic flow at the first network device, selecting from the plurality of groups, a target group in response to receiving the traffic flow, and routing the traffic flow received at the first network device to the second network device via the selected target group.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of an example architecture for a network fabric in accordance with various embodiments of the disclosure;

FIG. 2 is a schematic block diagram of an example network fabric in accordance with various embodiments of the disclosure;

FIG. 3 is a conceptual network diagram of a network device facilitating latency aware routing in accordance with various embodiments of the disclosure;

FIG. 4 is a schematic block diagram of an example architecture for a network fabric implementing latency aware routing in accordance with various embodiments of the disclosure;

FIG. 5 is a flowchart showing a process for routing a traffic flow in accordance with various embodiments of the disclosure;

FIG. 6 is a flowchart showing a process for latency aware routing in accordance with various embodiments of the disclosure;

FIG. 7 is a flowchart showing a process for classification of network paths in accordance with various embodiments of the disclosure;

FIG. 8 is a flowchart showing a process for latency aware traffic routing in a network fabric in accordance with various embodiments of the disclosure; and

FIG. 9 is a conceptual block diagram of a device suitable for configuration with a routing logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein to facilitate latency aware routing in a network. Disaggregated scheduled fabric (DSF) has emerged as a leading network topology/architecture, offering superior scalability, reduced latency, and simplified network management. DSF is a modular, scalable network fabric of interconnected components including spine nodes (e.g., switches), leaf nodes (e.g., switches), and interconnecting cables. The “spine nodes” act as core interconnects in the network fabric, providing high-speed, low-latency pathways between the leaf nodes. The spine nodes may not perform any routing and may primarily serve as high-capacity, low-latency links between the leaf nodes. The “leaf nodes” are edge devices that connect directly to “endpoint (EP) devices”, for example, servers, storage systems, Graphics Processing Units (GPUs), or other network endpoints. The leaf nodes may handle routing, traffic classification, and other network features, forwarding traffic through the spine nodes. The “interconnecting cables” are wired network paths of fixed or varied lengths connecting the leaf nodes to the spine nodes, forming a full-mesh connectivity where each leaf node is connected to each spine node.

Despite the various improvements offered by the DSF topology, it still has notable limitations. For example, in DSF topology, the connection between the spine nodes and the leaf nodes can be established using cables of fixed or varied length, introducing variability in network performance. Further, latency inconsistencies can arise in the network due to varied cable lengths and different paths that data may traverse from one leaf node to another. Even with uniform cable lengths, inherent differences in these paths can lead to latency discrepancies, which can be detrimental to latency-sensitive workflows.

Therefore, the present disclosure provides a network device (e.g., a leaf node in DSF architecture) that facilitates latency aware routing in the network. In other words, the network device facilitates an enhanced routing strategy that can dynamically manage traffic patterns and ensure consistent, low-latency connectivity across the network. In many embodiments, the leaf node may include a processor, a transceiver, and a memory communicatively coupled to the processor. The leaf node may be communicatively coupled to another leaf node through two or more network paths and each network path may be associated with a specific latency attribute. A network path may refer to a sequence of links and devices (e.g., spine nodes and other intermediate network nodes) that a data packet must traverse to reach its destination. Further, the latency attribute may be indicative of the time duration a data packet may take to travel from one point (e.g., a source node) in a network to another (e.g., a destination node). The latency attribute may be a function of propagation delay, transmission delay, processing delay, queuing delay, or the like. The leaf node may be further equipped with a routing logic (for example, stored in memory or implemented as a hardware component in the leaf node) to facilitate latency aware routing.

In a number of embodiments, the leaf node may be configured to determine the latency attribute associated with each of the two or more network paths. In a variety of embodiments, the leaf node may be configured to classify the two or more network paths into a plurality of groups based on the latency attribute of each of the two or more network paths. The plurality of groups may include, for example, a low latency group, a medium latency group, and a high latency group. The low latency group may have lower transmission latency than the high latency group while the medium latency group may have lower transmission latency than the high latency group and higher transmission latency than the low latency group. In order to classify the two or more network paths into the plurality of groups, the leaf node may be configured to compare the latency attribute of each of the two or more network paths with a latency threshold range of each of the plurality of groups. The network path may be classified into one of the plurality of groups that is associated with the latency threshold range encompassing the latency attribute of the network path. For example, a network path with a latency attribute in the low latency threshold range may be classified into the low latency group. Similarly, a network path with a latency attribute in the medium latency threshold range may be classified in the medium latency group, while another network path with a latency attribute in the high latency threshold range may be classified into the high latency group.

In additional embodiments, the leaf node may be configured to perform the comparison of the latency attribute with the latency threshold range based on a routing table. In other words, the leaf node may be configured to maintain the routing table including the plurality of groups, each group being associated with a corresponding latency threshold range. For example, the routing table may have a first entry in which the low latency group is mapped to a first upper threshold limit and a first lower threshold limit. The first upper threshold limit and the first lower threshold limit may correspond to upper and lower bounds, respectively, of the latency threshold range of the low latency group. Similarly, the routing table may have a second entry in which the medium latency group is mapped to a second upper threshold limit and a second lower threshold limit. Further, the routing table may have a third entry in which the high latency group is mapped to a third upper threshold limit and a third lower threshold limit. Thus, if the leaf node encounters a network path with a latency attribute that falls within the first upper threshold limit and the first lower threshold limit included in the routing table, the leaf node may classify the network path into the low latency group. Accordingly, the leaf node may classify the two or more network paths into the plurality of groups based on their latency attributes and the routing table.

In further embodiments, the leaf node may be configured to receive a traffic flow from a source device (e.g., a server) to be forwarded to a destination device connected to another leaf node. In response to receiving the traffic flow, in still more embodiments, the leaf node may select a target group from the plurality of groups and route the traffic flow to the destination device via the selected target group. In various embodiments, the traffic flow may be associated with a service parameter, for example, indicating a latency requirement associated with the traffic flow. In such embodiments, the leaf node may select the target group from the plurality of groups based on the service parameter. For example, if the leaf node determines that a received traffic flow is associated with a service parameter indicating a low latency requirement, the leaf node may look up in the routing table based on the service parameter (e.g., the low latency requirement) and select the low latency group, whose latency threshold range satisfies the service parameter, as the target group.

In still additional embodiments, with the target group being selected, the leaf node may be further configured to determine a count of network paths in the target group. If the target group includes only one network path, the leaf node may route the traffic flow to the destination device through the network path in the target group. However, in still further embodiments, if the target group includes more than one network path, the leaf node may execute load balancing among the network paths in the target group to route the traffic flow to the destination device. The load balancing may ensure that the traffic flow is distributed efficiently across network paths in the target group to avoid congestion on any select network path within the target group.

Thus, the network device (e.g., a leaf node) with enhanced latency aware routing may offer several key advantages. For example, by prioritizing network paths with lower latency, the network device may ensure that time-sensitive applications, such as real-time analytics and AI/ML training, receive data with minimal delays, enhancing their performance. By monitoring latency across the network, the network device can proactively avoid congested paths, reducing the likelihood of bottlenecks and maintaining smooth data flow. Further, applications that rely on quick response times, like video conferencing or online gaming, may benefit from reduced latency, leading to smoother and more reliable user experiences. Additionally, pre-emptive classification of the two or more network paths into different groups based on their latency attributes enables the network device to narrow its search to network paths in a specific group that is known to satisfy the latency requirements of a received traffic flow. By doing so, the computational overhead involved in path selection and load balancing is reduced. Moreover, classifying network paths based on latency attributes can facilitate scalability, enabling the network node to handle larger numbers of network paths without a proportional increase in complexity.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to the ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit. Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data. Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

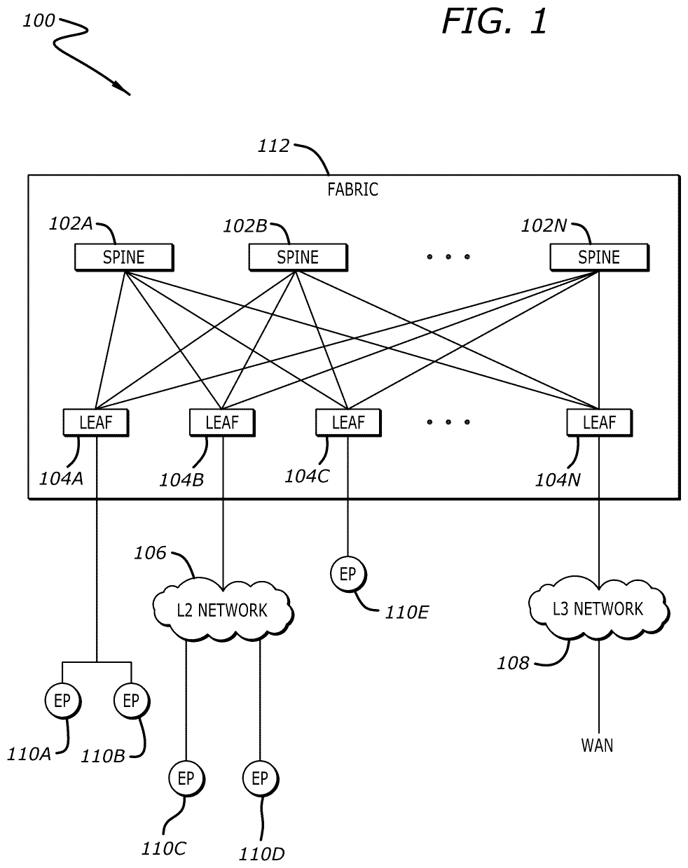

Referring to FIG. 1, a schematic block diagram of an example architecture 100 for a network fabric 112 in accordance with various embodiments of the disclosure is shown. The network fabric 112 can include spine switches 102A, 102B, . . . , 102N (collectively “102”) connected to leaf switches 104A, 104B, 104C . . . 104N (collectively “104”) in the network fabric 112. As those skilled in the art will recognize, networking fabric can refer to a high-speed, high-bandwidth interconnect system that enables multiple devices to communicate with each other efficiently and reliably. It is a network topology that is designed to provide a flexible and scalable infrastructure for data center, cloud environments, and other network elements.

Various embodiments described herein can include a leaf-spine architecture comprising a plurality of spine switches and leaf switches. Spine switches 102 can be L1 switches in the fabric 112. However, in some cases, the spine switches 102 can also, or otherwise, perform L2 functionalities. Further, the spine switches 102 can support various capabilities, such as, but not limited to, 40 or 10 Gbps Ethernet speeds. To this end, the spine switches 102 can be configured with one or more 40 Gigabit Ethernet ports. In certain embodiments, each port can also be split to support other speeds. For example, a 40 Gigabit Ethernet port can be split into four 10 Gigabit Ethernet ports, although a variety of other combinations are available.

In many embodiments, one or more of the spine switches 102 can be configured to host a proxy function that performs a lookup of the endpoint address identifier to locator mapping in a mapping database on behalf of leaf switches 104 that do not have such mapping. The proxy function can do this by parsing through the packet to the encapsulated tenant packet to get to the destination locator address of the tenant. The spine switches 102 can then perform a lookup of their local mapping database to determine the correct locator address of the packet and forward the packet to the locator address without changing certain fields in the header of the packet.

In various embodiments, when a packet is received at a spine switch 102i, wherein subscript “i” indicates that this operation may occur at any spine switch 102A to 102N, the spine switch 102i can first check if the destination locator address is a proxy address. If so, the spine switches 102i can perform the proxy function as previously mentioned. If not, the spine switch 102i can look up the locator in its forwarding table and forward the packet accordingly.

In a number of embodiments, one or more spine switches 102 can connect to one or more leaf switches 104 within the fabric 112. Leaf switches 104 can include access ports (or non-fabric ports) and fabric ports. Fabric ports can provide uplinks to the spine switches 102, while access ports can provide connectivity for devices, hosts, endpoints, VMs, or external networks to the fabric 112.

In numerous embodiments, leaf switches reside at the edge of the fabric 112, and can thus represent the physical network edge. In some cases, the leaf switches 104 can be top-of-rack (“ToR”) switches configured according to a ToR architecture. In other cases, the leaf switches 104 can be aggregation switches in any particular topology, such as end-of-row (EoR) or middle-of-row (MoR) topologies. The leaf switches 104 can also represent aggregation switches, for example.

In additional embodiments, the leaf switches 104 can be responsible for routing and/or bridging various packets and applying network policies. In some cases, a leaf switch can perform one or more additional functions, such as implementing a mapping cache, sending packets to the proxy function when there is a miss in the cache, encapsulating packets, enforcing ingress or egress policies, etc. Moreover, the leaf switches 104 can contain virtual switching functionalities, such as a virtual tunnel endpoint (VTEP) function. To this end, leaf switches 104 can connect the fabric 112 to an overlay network.

In further embodiments, network connectivity in the fabric 112 can flow through the leaf switches 104. Here, the leaf switches 104 can provide servers, resources, endpoints, external networks, or VMs access to the fabric 112, and can connect the leaf switches 104 to each other. In some cases, the leaf switches 104 can connect endpoint groups to the fabric 112 and/or any external networks. Each endpoint group can connect to the fabric 112 via one of the leaf switches 104, for example.

Endpoints 110 A-E (collectively “110”, shown as “EP”) can connect to the fabric 112 via leaf switches 104. For example, endpoints 110A and 110B can connect directly to leaf switch 104A, which can connect endpoints 110A and 110B to the fabric 112 and/or any other one of the leaf switches 104. Similarly, endpoint 110E can connect directly to leaf switch 104C, which can connect endpoint 110E to the fabric 112 and/or any other of the leaf switches 104. On the other hand, endpoints 110C and 110D can connect to leaf switch 104B via L2 network 106. Similarly, the wide area network (WAN) can connect to the leaf switch 104N via L3 network 108.

In certain embodiments, endpoints 110 can include any communication device, such as a computer, a server, a switch, a router, etc. In some cases, the endpoints 110 can include a server, hypervisor, a Graphics Processing Unit (GPU), or switch configured with a VTEP functionality which connects an overlay network, with the fabric 112. For example, in some cases, the endpoints 110 can represent one or more of the VTEPs. The overlay network can host physical devices, such as servers, applications, endpoint groups, virtual segments, virtual workloads, etc. In addition, the endpoints 110 can host virtual workload(s), clusters, and applications or services, which can connect with the fabric 112 or any other device or network, including an external network. For example, one or more endpoints 110 can host, or connect to, a cluster of load balancers or an endpoint group of various applications.

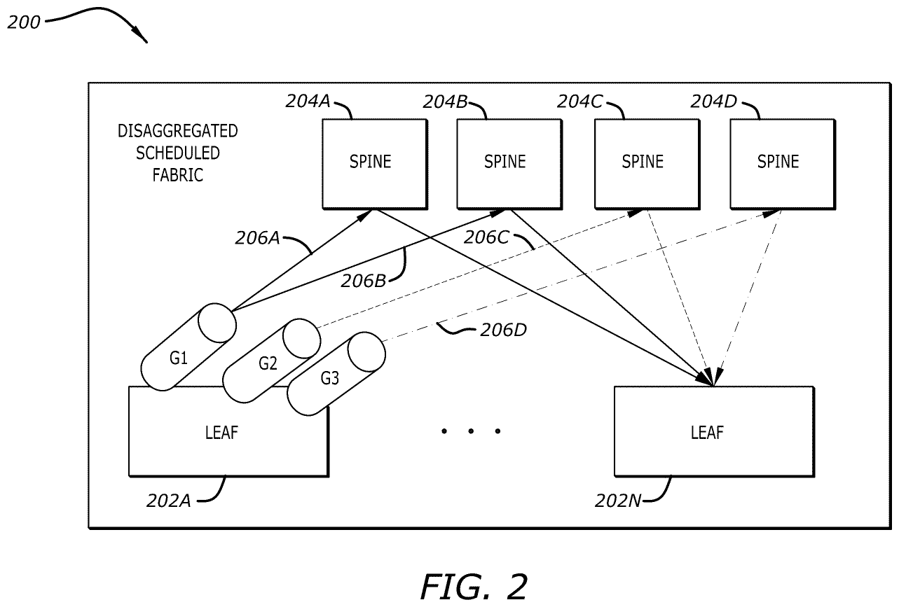

Although a specific embodiment for an architecture 100 is described above with respect to FIG. 1, any of a variety of systems and/or processes may be utilized in accordance with embodiments of the disclosure. For example, the architecture 100 could comprise any variety of endpoints, spine switches, and/or leaf switches. The elements depicted in FIG. 1 may also be interchangeable with other elements of FIGS. 2-9 as required to realize a particularly desired embodiment. More details about an overlay network are described in more detail below.

Referring to FIG. 2, a schematic block diagram of an example network fabric 200 in accordance with various embodiments of the disclosure is shown. In many embodiments, the network fabric 200 may be a Disaggregated Scheduled Fabric (DSF) that may include a plurality of disaggregated components such as spine switches, leaf switches, and interconnecting cables. In a number of embodiments, the network fabric 200 may include leaf switches 202A, 202B, . . . , and 202N (collectively designated as “202”) connected to spine switches 204A, 204B, 204C, and 204D (collectively designated as “204”), for example, forming a full-mesh connectivity. The network fabric 200 can refer to a high-speed, high-bandwidth interconnect system that enables multiple devices to communicate with each other efficiently and reliably. The network fabric 200 may conform to a network topology that provides a flexible and scalable infrastructure for data center, cloud environments, and other network elements.

In a variety of embodiments, the spine switches 204 can be L1 switches in the network fabric 200. However, in some cases, the spine switches 204 can also, or otherwise, perform L2 functionalities. The spine switches 204 may operate as the core of the network fabric 200, providing interconnectivity between the leaf switches 202. For example, one or more spine switches 204 can connect to one or more leaf switches 202 within the network fabric 200.

In various embodiments, the leaf switches 202 may reside at the edge of the network fabric 200, and can thus represent the physical network edge. In some cases, the leaf switches 202 can be ToR switches configured according to a ToR architecture. In other cases, the leaf switches 202 can be aggregation switches in any particular topology, such as EoR or MoR topologies. The leaf switches 202 can also represent aggregation switches, for example.

In yet various embodiments, each leaf switch 202 may be connected to another leaf switch 202 through two or more network paths. For example, a network path connecting two leaf switches may include a sequence of links and one or more spine switches. In other words, the leaf switches 202 may have no direct leaf-to-leaf connectivity and may be connected to each other via interconnecting cables and the spine switches 204. In the example network fabric 200, the leaf switch 202A is shown to be connected to the leaf switch 202N through four network paths, such as a first network path 206A, a second network path 206B, a third network path 206C, and a fourth network path 206D. The first network path 206A may connect the leaf switches 202A and 202N via the spine switch 204A and interconnecting cables. Similarly, the second network path 206B may connect the leaf switches 202A and 202N via the spine switch 204B and interconnecting cables. The third network path 206C may connect the leaf switches 202A and 202N via the spine switch 204C and interconnecting cables, and the fourth network path 206D may connect the leaf switches 202A and 202N via the spine switch 204D and interconnecting cables.

In several embodiments, network paths in the network fabric 200 may be of varied cable lengths and can be associated with different latency attributes. Latency may refer to the time it takes for data to travel from one point to another on a specific network path. Latency may not only be influenced by cable length but also by other factors such as a number of hops data passes through and processing delays at each hop in the network path. In other words, the latency attribute can be a function of propagation delay, transmission delay, processing delay, queuing delay, or the like associated with a network path. In several more embodiments, because of varied cable lengths and other factors affecting latency, each of the network paths can be associated with a unique latency attribute, introducing variability in network performance.

In order to facilitate an enhanced routing strategy that can dynamically manage traffic patterns and ensure consistent, low-latency connectivity across the network fabric 200, the leaf switches 202 may include a routing logic. The routing logic may include suitable logic, circuitry, interfaces, and/or code, executable by the circuitry, that may be configured to enable latency aware routing in the network fabric 200. For the sake of brevity, latency aware routing is described with respect to the leaf switches 202A and 202N. However, it will be apparent to a person of ordinary skill in the art that other leaf switches 202B-N can also execute the latency aware routing in a similar manner as described for the leaf switch 202A, and that the leaf switch 202A can execute the latency aware routing for transmitting data to other leaf switches 202B-202(N−1) in a similar manner as described for the leaf switch 202N.

In further embodiments, the leaf switch 202A may be configured to determine the latency attribute of each of the first through fourth network paths 206A-D. In an example scenario, the leaf switch 202A may determine the latency attribute of the first through fourth network paths 206A-D by utilizing a probing technique. The leaf switch 202A may utilize various tools (such as Traceroute, Ping, or the like) to determine the latency attribute of each of the first through fourth network paths 206A-D. In an example, the leaf switch 202A may determine that the first through fourth network paths 206A-D are associated with first through fourth latency attributes, respectively.

In additional embodiments, the leaf switch 202A may be configured to classify the first through fourth network paths 206A-D into a plurality of groups based on the determined latency attribute of each of the first through fourth network paths 206A-D. In more embodiments, the plurality of groups may include, for example, a low latency group G1, a medium latency group G2, and a high latency group G3. The low latency group G1 may have lower transmission latency than the high latency group G3 while the medium latency group G2 may have lower transmission latency than the high latency group G3 and higher transmission latency than the low latency group G1. Further, each group of the plurality of groups may be associated with a unique latency threshold range. For example, the low latency group G1 may be associated with a first latency threshold range, the medium latency group G2 may be associated with a second latency threshold range, and the high latency group G3 may be associated with a third latency threshold range.

In order to classify the first through fourth network paths 206A-D into the plurality of groups, the leaf switch 202A may be configured to compare the latency attribute of each of the first through fourth network paths 206A-D with the latency threshold range of each of the plurality of groups. A network path may be classified into one of the plurality of groups that is associated with a latency threshold range encompassing the latency attribute of the network path. For example, a network path with a latency attribute in the first latency threshold range may be classified into the low latency group G1. Similarly, a network path with a latency attribute in the second latency threshold range may be classified in the medium latency group G2, while another network path with a latency attribute in the third latency threshold range may be classified in the high latency group G3.

In still more embodiments, the leaf switch 202A may be configured to compare the latency attribute of each of the first through fourth network paths 206A-D with the latency threshold range of each of the plurality of groups based on a routing table. In other words, the leaf switch 202A may be configured to maintain the routing table including the plurality of groups, each group being associated with a corresponding latency threshold range in the routing table. For example, the routing table may have a first entry in which the low latency group G1 is mapped to a first upper threshold limit and a first lower threshold limit. The first upper threshold limit and the first lower threshold limit may correspond to the upper and lower bounds, respectively, of the first latency threshold range. Similarly, the routing table may have a second entry in which the medium latency group G2 is mapped to a second upper threshold limit and a second lower threshold limit. The second upper threshold limit and the second lower threshold limit may correspond to the upper and lower bounds, respectively, of the second latency threshold range. Further, the routing table may have a third entry in which the high latency group G3 is mapped to a third upper threshold limit and a third lower threshold limit. The third upper threshold limit and the third lower threshold limit may correspond to the upper and lower bounds, respectively, of the third latency threshold range. Thus, if the leaf switch 202A encounters a network path with a latency attribute that falls within the first upper threshold limit and the first lower threshold limit included in the routing table, the leaf switch 202A may classify the network path into the low latency group G1. Accordingly, the leaf switch 202A may classify the first through fourth network paths 206A-D into the plurality of groups based on their latency attributes and the routing table. For example, as shown in FIG. 2, the first and second network paths 206A and 206B are classified into the low latency group G1. The third network path 206C is classified into the medium latency group G2. Further, the fourth network path 206D is classified into the high latency group G3.

Although a specific embodiment for the network fabric 200 suitable for carrying out the various steps, processes, methods, and operations described herein is discussed with respect to FIG. 2, any of a variety of systems and/or processes may be utilized in accordance with embodiments of the disclosure. For example, in many further embodiments, the plurality of groups can include any number of groups, not limiting to three as shown in FIG. 2, based on latency grouping. In an example, based on latency grouping, the plurality of groups can include five groups: very low latency group, low latency group, medium-low latency group, medium-high latency group, and high latency group, each having a corresponding latency threshold range. In another example, based on latency grouping, the plurality of groups can include four groups: very low latency group, low latency group, medium latency group, and high latency group, each having a corresponding latency threshold range. The elements depicted in FIG. 2 may also be interchangeable with other elements of FIG. 1 and FIGS. 3-9 as required to realize a particularly desired embodiment.

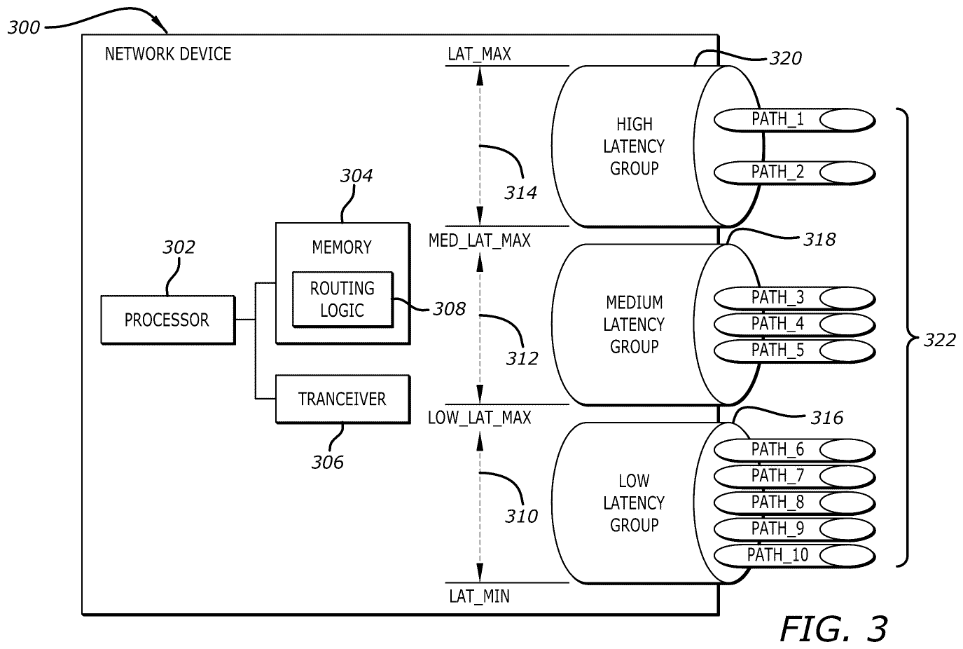

Referring to FIG. 3, a conceptual diagram of a network device 300 facilitating latency aware routing in accordance with various embodiments of the disclosure is shown. In many embodiments, the network device 300 may include one or more processor(s) 302 (hereinafter referred to as “the processor 302”), a memory 304 communicatively coupled to the processor 302, and a transceiver 306. In many examples, the network device 300 can be a leaf switch. However, in many further examples, the network device 300 can be any network node that is required to route traffic across multiple network paths. In a non-limiting example, the network device 300 is shown to be associated with ten network paths ‘Path_1’, . . . , ‘Path_10’ (collectively referred to as “network paths 322”).

In many embodiments, the processor 302 may be implemented as one or more microprocessors, microcomputers, microcontrollers, digital signal processors, central processing units, logic circuitries, and/or any devices that process data based on operational instructions. Among other capabilities, the processor 302 may be configured to fetch and execute computer-readable instructions stored in the memory 304 of the network device 300. Further examples of the processor 302 may include an Application-Specific Integrated Circuit (ASIC) processor, a Reduced Instruction Set Computing (RISC) processor, a Complex Instruction Set Computing (CISC) processor, a Field-Programmable Gate Array (FPGA), or the like.

In a number of embodiments, the memory 304 may be configured to store one or more computer-readable instructions or routines in a non-transitory computer-readable storage medium, which may be fetched and executed to create or share data packets over a network path. The memory 304 may include any non-transitory storage device including, for example, volatile memory such as random-access memory (RAM), a read-only memory (ROM), or non-volatile memory such as EPROM, a hard disk drive (HDD), a flash memory, a solid-state memory, and the like. It will be apparent to a person skilled in the art that the scope of the disclosure is not limited to realizing the memory 304 in the network device 300, as described herein. In a variety of embodiments, the memory 304 may be realized in the form of a database server or a cloud storage working in conjunction with the network device 300, without departing from the scope of the disclosure.

In more embodiments, the transceiver 306 may include suitable logic, circuitry, interfaces, and/or code, executable by the circuitry, that may be configured to perform one or more operations associated with transmitting and receiving data in a network. The transceiver 306 may also provide a communication pathway for one or more components of the network device 300. Examples of the transceiver 306 may further include, but are not limited to, an antenna, a radio frequency transceiver, a wireless transceiver, a Bluetooth transceiver, an ethernet port, or any other device configured to transmit and receive data.

In additional embodiments, the memory 304 may include a routing logic 308. The routing logic 308 may include suitable logic, circuitry, interfaces, and/or code, executable by the circuitry, that may be configured to perform one or more operations for latency aware routing. Those skilled in the art will recognize that the routing logic 308 can include various hardware and/or software deployments and can be configured in a variety of ways.

In further embodiments, the routing logic 308 may be configured to determine a latency attribute of each of the network paths 322 and classify the network paths 322 into a plurality of groups. Each of the plurality of groups may be associated with a corresponding latency threshold range. In an example scenario, the plurality of groups is shown to include a low latency group 316, a medium latency group 318, and a high latency group 320. Further, the low latency group 316 is associated with a first latency threshold range 310 defined between a first upper threshold limit (denoted as “low_LAT_max”) and a first lower threshold limit (denoted as “LAT_min”). The medium latency group 318 is associated with a second latency threshold range 312 defined between a second upper threshold limit (denoted as “med_LAT_max”) and a second lower threshold limit (denoted as “low_LAT_max”). Likewise, the high latency group 320 is associated with a third latency threshold range 314 defined between a third upper threshold limit (denoted as “LAT_max”) and a third lower threshold limit (denoted as “med_LAT_max”). In an example, the first upper threshold limit can be represented as equation 1 and the second upper threshold limit can be represented as equation 2 shown below:

$$Low\_LAT \_max = LAT\_min + X \qquad ( 1 )$$

$$med\_LAT \_max = low\_LAT \_max + Y \qquad ( 2 )$$

In several embodiments, a relationship between the first latency threshold range 310, the first latency threshold range 312, and the third latency threshold range 314 can be represented as equation 3 shown below:

$$LAT\_min < low\_LAT \_max < med\_LAT \_max < LAT\_max \qquad ( 3 )$$

In further additional embodiments, a mapping between the plurality of groups and corresponding latency threshold ranges may be stored in a routing table. To classify the network paths 322 into the plurality of groups, in still more embodiments, the routing logic 308 may be configured to compare the latency attribute of each of the network paths 322 with the latency threshold ranges of the plurality of groups. Based on the comparison, a network path may be classified into one of the plurality of groups that is associated with a latency threshold range encompassing the latency attribute of the network path. In other words, network paths with latency attributes in the first latency threshold range 310 may be classified into the low latency group 316. Similarly, network paths with latency attributes in the second latency threshold range 312 may be classified into the medium latency group 318, and network paths with latency attributes in the third latency threshold range 314 may be classified into the high latency group 320.

In an example shown in FIG. 3, the routing logic 308 may classify five network paths (Path_6, . . . , Path_10) into the low latency group 316 based on the comparison. Further, the routing logic 308 may classify three network paths (Path_3, . . . , Path_5) in the medium latency group 318. Further, the routing logic 308 may classify the remaining two network paths (Path_1 and Path_2) into the high latency group 320. In other words, each of the plurality of groups includes a set of network paths, of the network paths 322, classified into corresponding group.

Although a specific embodiment for illustrating a network device facilitating latency aware routing suitable for carrying out the various steps, processes, methods, and operations described herein is discussed with respect to FIG. 3, any of a variety of systems and/or processes may be utilized in accordance with embodiments of the disclosure. In many non-limiting examples, the routing logic 308 can be configured as a standalone device, exist as a logic in another network device, be distributed among various network devices operating in tandem, or remotely operated as part of a cloud-based network management tool. In many additional examples, the routing logic 308 can be implemented as a standalone component within the network device 300. The elements depicted in FIG. 3 may also be interchangeable with other elements of FIGS. 1-2 and FIGS. 4-9 as required to realize a particularly desired embodiment.

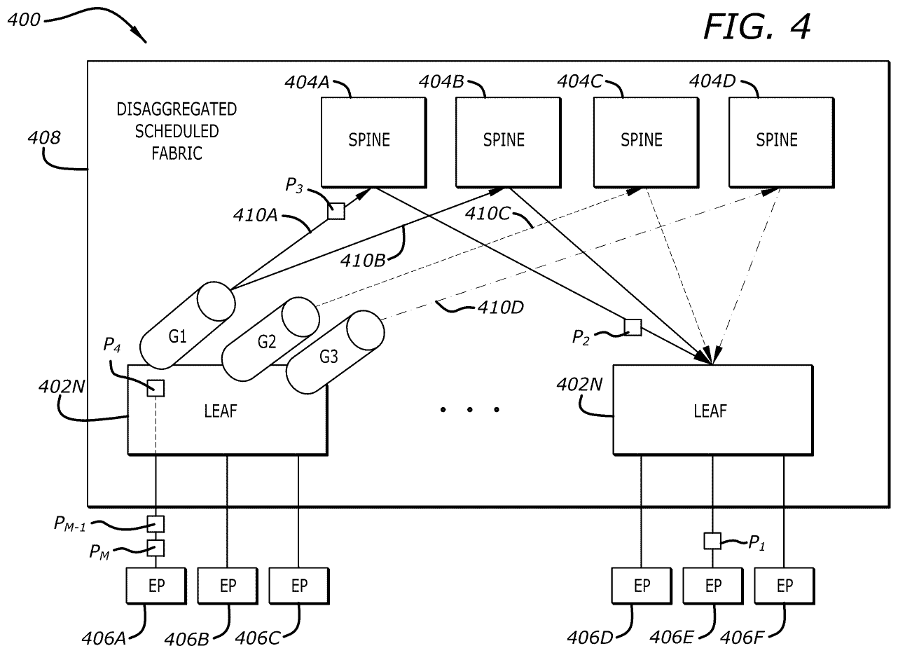

Referring to FIG. 4, a schematic block diagram of an example architecture 400 for a network fabric 408 implementing latency aware routing in accordance with various embodiments of the disclosure is shown. The embodiments shown in FIG. 4 may illustrate a scenario where the network fabric 408 may include leaf switches 402A, 402B, . . . , and 402N (collectively referred to as “402”) connected to spine switches 404A, 404B, 404C, and 404D (collectively referred to as “404”). Further, endpoints 406A-F (collectively “406”, shown as “EP”) can connect to the network fabric 408 via the leaf switches 402. For example, the endpoints 406A, 406B, and 406C can connect directly to the leaf switch 402A, which can connect the endpoints 406A, 406B, and 406C to the network fabric 408 and/or any other one of the leaf switches 402. Similarly, the endpoints 406D, 406E, and 406F can connect directly to the leaf switch 402N, which can connect the endpoints 406D, 406E, and 406F to the network fabric 408 and/or any other one of the leaf switches 402. In a non-limiting example, the endpoints 406 may include servers, computers, switches, routers, or the like.

As shown in FIG. 4, the leaf switch 402A is connected to the leaf switch 402N through four network paths, e.g., first through fourth network paths 410A-410D (collectively referred to as “410”). Further, the first and second network paths 410A and 410B are shown to have been classified into a first group G1, the third network path 410C is classified into a second group G2, and the fourth network path 410D is classified into a third group G3. In numerous embodiments, the first group G1 may correspond to a low latency group, the second group G2 may correspond to a medium latency group, and the third group G3 may correspond to a high latency group. The low latency group may have lower transmission latency than the high latency group. Further, the medium latency group may have lower transmission latency than the high latency group and higher transmission latency than the low latency group.

In many embodiments, the leaf switch 402A may be configured to maintain a routing table including information regarding the first through third groups G1, G2, and G3. For example, the routing table may include information regarding latency threshold ranges of the first through third groups G1, G2, and G3. For example, the routing table may include a first entry in which the first group G1 is mapped to a first upper threshold limit and a first lower threshold limit. The first upper threshold limit and the first lower threshold limit may correspond to the upper and lower bounds, respectively, of a first latency threshold range associated with the first group G1. Similarly, the routing table may include a second entry in which the second group G2 is mapped to a second upper threshold limit and a second lower threshold limit. The second upper threshold limit and the second lower threshold limit may correspond to the upper and lower bounds, respectively, of a second latency threshold range associated with the second group G2. Further, the routing table may include a third entry in which the third group G3 is mapped to a third upper threshold limit and a third lower threshold limit. The third upper threshold limit and the third lower threshold limit may correspond to the upper and lower bounds, respectively, of a third latency threshold range associated with the third group G3.

In a number of embodiments, the leaf switch 402A may receive a traffic flow including one or more data packets (shown as P₁, P₂, P₃, P₄, . . . , Pₘ₋₁, and Pₘ) from the endpoint 406A. In an example, a destination of the traffic flow may be the endpoint 406D connected to the leaf switch 402N. Further, the traffic flow may be associated with a service parameter. The service parameter may be configured to indicate a latency requirement associated with the traffic flow. For example, the traffic flow may be an AI/ML workflow with the service parameter indicating a low latency requirement. In various embodiments, an AI/ML workflow may involve various tasks such as training deep learning models, running large-scale simulations, processing massive datasets, or the like. Examples of AI/ML workflows can include, but are not limited to, image and speech recognition, natural language processing, predictive analytics, or the like. An AI/ML workflow may require substantial computational power and parallel processing capabilities to efficiently handle complex calculations, manage large neural networks, and iterate rapidly over extensive datasets. As a result, the AI/ML workflows, in yet various embodiments, may be associated with stringent latency requirements, for example, low latency requirements.

In response to receiving the traffic flow (for example, a first data packet P₁ of the traffic flow), the leaf switch 402A may check the service parameter of the traffic flow to understand the latency requirement. In the current example, the leaf switch 402A may determine that the service parameter indicates the low latency requirement. The leaf switch 402A may be further configured to perform a forwarding look up (e.g., in the routing table) based on the service parameter to select a target group, among the first through third groups G1, G2, and G3, for routing the traffic flow. In other words, the leaf switch 402A may look up in the routing table based on the service parameter (e.g., the low latency requirement) and select one of the first through third groups G1, G2, and G3 as the target group having a corresponding latency threshold range that satisfies the service parameter. Continuing the above example, based on the look up in the routing table, the leaf switch 402A may determine that the first latency threshold range of the first group G1 satisfies the low latency requirement of the traffic flow. In such a scenario, the leaf switch 402A may select the first group G1 as the target group for routing the traffic flow.

With the first group G1 being selected as the target group, the leaf switch 402A may determine if load balancing is required or not. In a scenario if a target group includes more than one network path, the leaf switch 402A may deduce that load balancing is required; however, if a target group includes only one network path, the leaf switch 402A may deduce that load balancing is not required. In the current example, the first group G1 includes two network paths 410A and 410B. Thus, the leaf switch 402A may be configured to perform load balancing to distribute traffic across the first and second network paths 410A and 410B in the first group G1. Load balancing may ensure that traffic is distributed efficiently across the first and second network paths 410A and 410B, avoiding congestion across one specific network path. Examples of load balancing techniques may include, but are not limited to, Equal-Cost Multi-Path (ECMP) routing, Link Aggregation Control Protocol (LACP) routing, Adaptive Load Balancing, Source-Destination Hashing, Flow-based Load Balancing, Dynamic Load Balancing, weighted random load balancing, or the like.

For example, in the example scenario shown in FIG. 4, the leaf switch 402A may select the first network path 410A based on load balancing and route the one or more data packets (shown as P₁, P₂, P₃, P₄, . . . , Pₘ₋₁, and Pₘ) to the leaf switch 402N via the selected first network path 410A. The leaf switch 402N may further transmit the received one or more data packets (shown as P₁, P₂, P₃, P₄, . . . , Pₘ₋₁, and Pₘ) to the endpoint 406D.

Although a specific embodiment for a network fabric 408 implementing latency aware routing suitable for carrying out the various steps, processes, methods, and operations described herein is discussed with respect to FIG. 4, any of a variety of systems and/or processes may be utilized in accordance with embodiments of the disclosure. In many examples, the network fabric 408 may receive other traffic flows with relaxed latency requirements (e.g., medium or high latency). In such a scenario, the leaf switch 402A can select any of the second or third groups G2 and G3, catering to medium and high latency requirements, as the target group. The network paths in the second and third groups G2 and G3 may be utilized to transfer traffic flows that do not have stringent latency requirements, ensuring that the leaf switch 402A can handle diverse traffic types without compromising the performance of latency-sensitive applications. The elements depicted in FIG. 4 may also be interchangeable with other elements of FIGS. 1-3 and FIGS. 5-9 as required to realize a particularly desired embodiment.

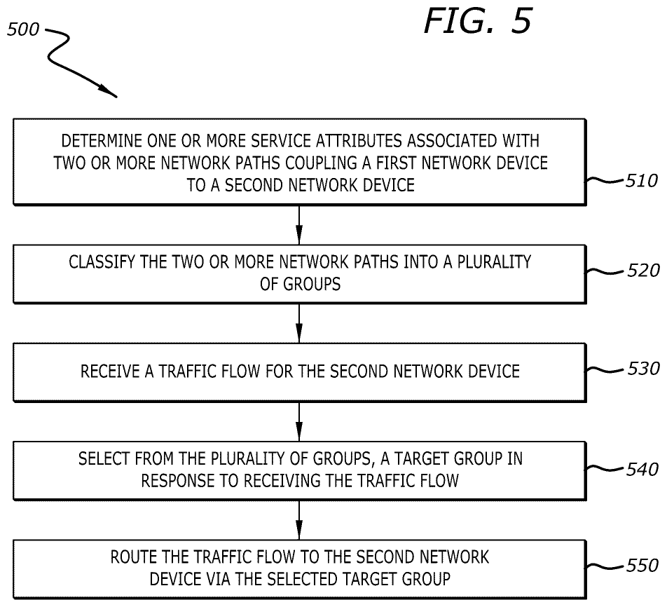

Referring to FIG. 5, a flowchart showing a process 500 for routing a traffic flow in accordance with various embodiments of the disclosure. In many embodiments, the process 500 may determine one or more service attributes associated with two or more network paths coupling a first network device to a second network device (block 510). In various embodiments, the first network device and the second network device are leaf switches in a network fabric that are connected to each other through different network paths, each network path including a different spine switch. In an example, the network fabric is a Disaggregated Scheduled Fabric. Thus, the process 500 may identify and evaluate multiple network paths in the network fabric that connect the first network device to the second network device. In several embodiments, the one or more service attributes of each network path may include, for example, a latency attribute, a bandwidth, a path length, or the like. For example, some network paths may have shorter physical distances than others Similarly, some network paths may offer higher bandwidth than others. Additionally, network paths can also vary in terms of latency. By determining the service attributes, the process 500 can make informed decisions about which network paths are best suited for different types of traffic flows.

In a number of embodiments, the process 500 may classify the two or more network paths into a plurality of groups (block 520). More specifically, the process 500 may classify the two or more network paths into the plurality of groups based on the determined one or more service attributes. For example, the process 500 may utilize fabric next hop groups to classify the two or more network paths. A next hop group can be referred to as a set of next hop addresses that are grouped based on certain common service attributes. For example, network paths exhibiting latency within a first latency threshold range can be classified into a first group while network paths exhibiting latency within a second latency threshold range can be classified into a second group. Likewise, network paths having bandwidths within a first bandwidth threshold range can be classified into a first group while network paths having bandwidths within a second bandwidth threshold range can be classified into a second group. In other words, network paths exhibiting similar service attributes are classified into the same group.

In a variety of embodiments, the process 500 may receive a traffic flow for the second network device (block 530). The traffic flow may include one or more data packets that need to be transmitted by the first network device to the second network device. In numerous embodiments, the first network device may receive the traffic flow from an endpoint device, for example, a server, a GPU, a user device, or the like. In further embodiments, the traffic flow can be an AI/ML workflow.

In several more embodiments, the process 500 may select from the plurality of groups, a target group in response to receiving the traffic flow (block 540). In other words, the process 500 may select the most appropriate group that can satisfy a service parameter associated with the traffic flow. For example, if the traffic flow is a bandwidth-sensitive traffic flow, the process 500 may choose a group, from the plurality of groups, that may offer a required bandwidth for the traffic flow. In another example, if the traffic flow is a latency-sensitive traffic flow, the process 500 may choose a group, from the plurality of groups, that may offer a required latency range for the traffic flow. In other words, one of the plurality of groups whose service attributes aligns with the service parameter of the traffic flow is selected by the process 500 as the target group.

In additional embodiments, the process 500 may route the traffic flow to the second network device via the selected target group (block 550). In other words, the process 500 may route the traffic flow to the second network device utilizing at least one network path in the selected target group.

Although a specific embodiment for routing traffic flow suitable for carrying out the various steps, processes, methods, and operations described herein is discussed with respect to FIG. 5, any of a variety of systems and/or processes may be utilized in accordance with embodiments of the disclosure. For example, the process 500 may utilize one or more load-balancing schemes to distribute traffic between network paths of the selected target group, ensuring balanced utilization. Thus, preventing any single network path in the selected target group from becoming overutilized while others in the same group remain underutilized. The elements depicted in FIG. 5 may also be interchangeable with other elements of FIGS. 1-4 and 6-9 as required to realize a particularly desired embodiment.

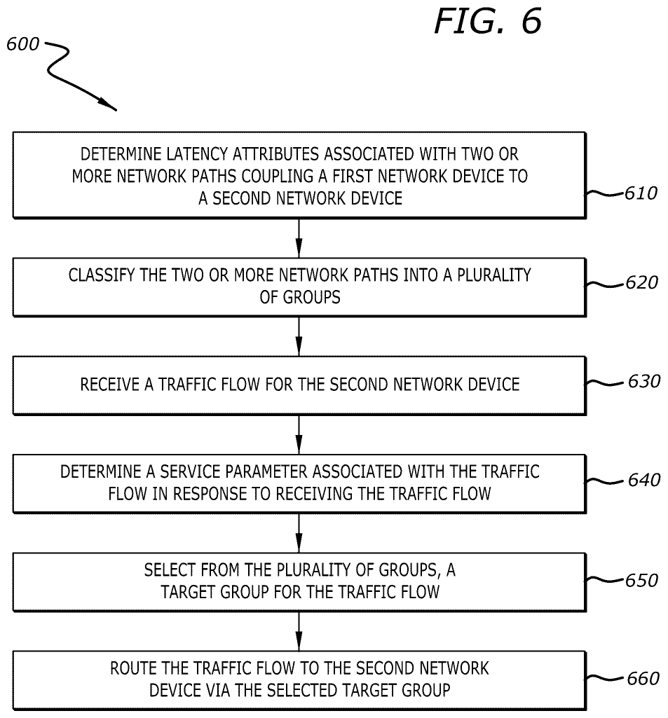

Referring to FIG. 6, a flowchart showing a process 600 for latency aware routing in accordance with various embodiments of the disclosure. In many embodiments, the process 600 may determine latency attributes associated with two or more network paths coupling a first network device to a second network device (block 610). In various embodiments, the first network device and the second network device may be leaf switches in a network fabric that are connected to each other through the two or more network paths. In an example, the network fabric can be a Disaggregated Scheduled Fabric. Determining the latency attributes may involve measuring the time it takes for data to travel along each network path, accounting for any delays due to distance, network congestion, or other factors. This information on the latency attributes may be required to understand the performance capabilities of each network path. In an example scenario, the process 600 may determine the latency attributes of the two or more network paths by utilizing a probing technique. Various tools that can be used for probing the two or more network paths may include Traceroute, Ping, or the like.

In a number of embodiments, the process 600 may classify the two or more network paths into a plurality of groups (block 620). More specifically, the process 600 may classify the two or more network paths into the plurality of groups based on the determined latency attributes. In an example, the plurality of groups may include a low latency group, a medium latency group, and a high latency group. The low latency group may have lower transmission latency than the high latency group. Further, the medium latency group may have lower transmission latency than the high latency group and higher transmission latency than the low latency group. In other words, network paths exhibiting similar latency attributes are classified into the same group. By classifying the two or more network paths, the process 600 may effectively manage and select network paths that meet specific latency requirements.

In a variety of embodiments, the process 600 may receive a traffic flow for the second network device (block 630). The traffic flow may include one or more data packets that need to be transmitted by the first network device to the second network device. In numerous embodiments, the first network device may receive the traffic flow from an endpoint device, for example, a server, a GPU, a user device, or the like. In further embodiments, the traffic flow can be an AI/ML workflow.

In several embodiments, the process 600 may determine a service parameter associated with the traffic flow in response to receiving the traffic flow (block 640). In an example, the service parameter may be configured to indicate a latency requirement associated with the traffic flow. In numerous additional embodiments, the process 600 can determine the latency requirement (e.g., service parameter) of the traffic flow by analyzing a type of application or service generating the traffic flow and its corresponding quality of service (QOS) parameters. Real-time applications such as voice over IP (VOIP) or online gaming may have low latency requirements to ensure smooth and uninterrupted communication. In other words, applications may have pre-defined latency thresholds, and the process 600 can determine the latency requirement by identifying an application associated with the traffic flow. Additionally, service-level agreements (SLAs) associated with the traffic flow can also indicate the latency requirement associated with the traffic flow. Thus, the process 600 can reference the SLAs of the traffic flow to determine the service parameter. Moreover, various traffic classification mechanisms, such as Differentiated Services Code Point (DSCP) in an Internet Protocol (IP) header, can indicate the latency requirement. Thus, the process 600 may inspect packet headers of data packets in the traffic flow to determine the service parameter associated with the traffic flow.

In more embodiments, the process 600 may select from the plurality of groups, a target group for the traffic flow (block 650). In other words, the process 600 may select the most appropriate group that can satisfy the service parameter associated with the traffic flow. For example, if the traffic flow is a latency-sensitive traffic flow, the process 600 may choose a group, from the plurality of groups, that may offer a required latency range for the traffic flow. In other words, one of the plurality of groups whose latency attributes aligns with the service parameter of the traffic flow is selected by the process 600 as the target group.

In still more embodiments, the process 600 may route the traffic flow to the second network device via the selected target group (block 660). In other words, the process 600 may forward one or more data packets of the traffic flow to the second network device by utilizing the selected target group. The process 600 may route the traffic flow to the second network device utilizing at least one network path classified into the selected target group. The process 600 may utilize one or more load balancing schemes to distribute traffic between network paths of the selected target group, ensuring balanced utilization.

Although a specific embodiment for routing of traffic flow suitable for carrying out the various steps, processes, methods, and operations described herein is discussed with respect to FIG. 6, any of a variety of systems and/or processes may be utilized in accordance with embodiments of the disclosure. For example, the process 600 may select the target group by performing a forwarding look up in a routing table based on the service parameter of the traffic flow. The elements depicted in FIG. 6 may also be interchangeable with other elements of FIGS. 1-5 and 7-9 as required to realize a particularly desired embodiment.

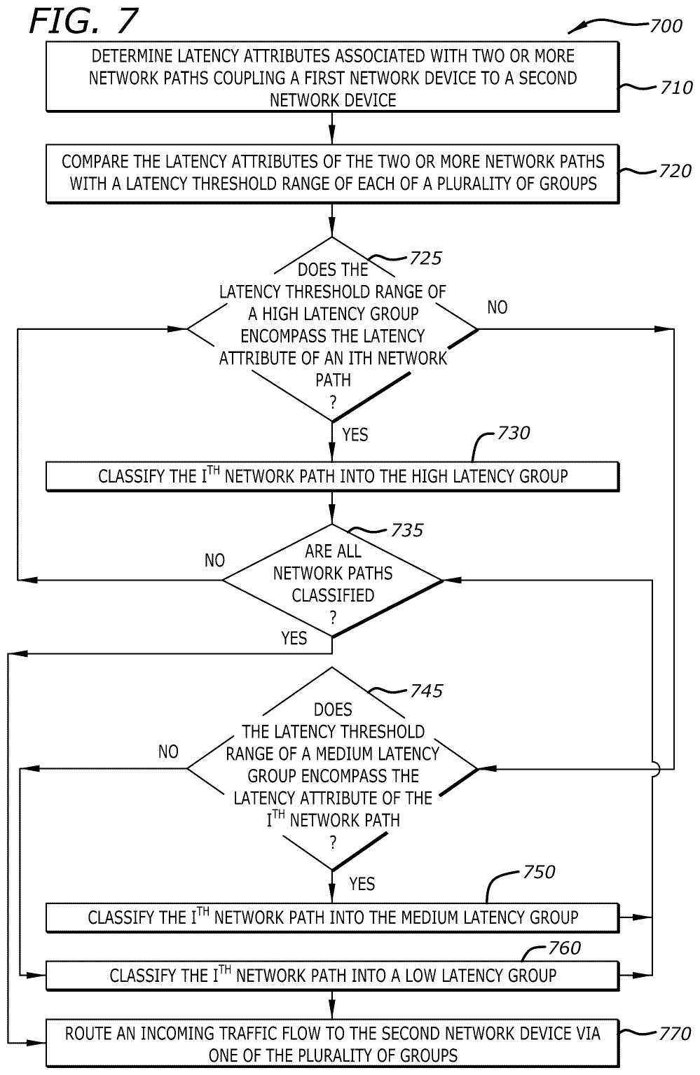

Referring to FIG. 7, a flowchart showing a process 700 for classification of network paths in accordance with various embodiments of the disclosure is shown. In many embodiments, the process 700 may determine latency attributes associated with two or more network paths coupling a first network device to a second network device (block 710). In various embodiments, the first network device and the second network device may be leaf switches in a network fabric that are connected to each other through the two or more network paths. In an example, the network fabric can be a Disaggregated Scheduled Fabric. Determining the latency attributes may involve measuring the time it takes for data to travel along each network path, accounting for any delays due to distance, network congestion, or other factors. This information on the latency attributes may be required to understand the performance capabilities of each network path. In an example scenario, the process 700 may determine the latency attributes of the two or more network paths by utilizing a probing technique. Various tools that can be used for probing the two or more network paths may include Traceroute, Ping, or the like.

In a variety of embodiments, the process 700 may compare the latency attributes of the two or more network paths with a latency threshold range of each of a plurality of groups (block 720). The plurality of groups may include, for example, a low latency group, a medium latency group, and a high latency group. The low latency group may have lower transmission latency than the high latency group. Further, the medium latency group may have lower transmission latency than the high latency group and higher transmission latency than the low latency group. Further, the low latency group may be associated with a first latency threshold range, the medium latency group may be associated with a second latency threshold range, and the high latency group may be associated with a third latency threshold range. A network path may be classified into one of the plurality of groups that is associated with a latency threshold range encompassing the latency attribute of the network path.

In a number of embodiments, the process 700 may determine whether the latency threshold range of the high latency group encompasses the latency attribute of an i^{th} network path (block 725). Here, “i^{th}” network path indicates that this operation can occur for any network path among the two or more network paths. For example, the latency threshold range of the high latency group may be defined by a first upper threshold limit and a first lower threshold limit. Thus, the process 700 may determine whether the latency attribute of the i^{th} network path is within the first upper threshold limit and the first lower threshold limit.

Thus, if the latency threshold range of the high latency group encompasses the latency attribute of the i^{th} network path, in numerous embodiments, the process 700 may classify the i^{th} network path into the high latency group (block 730). Classifying the i^{th} network path into the high latency group may correspond to including the i^{th} network path into a next hop group created for high latency category.

In additional embodiments, the process 700 may determine whether all network paths are classified (block 735). In other words, after classifying the i^{th} network path, the process 700 may check if all network paths have been classified into one of the plurality of groups. If all the network paths connecting the first network device to the second network device are not classified, for a next remaining network path (e.g., next i^{th} network path), the process 700 may determine whether the latency threshold range of the high latency group encompasses the latency attribute of the i^{th} network path (block 725).

If the latency threshold range of the high latency group does not encompass the latency attribute of the i^{th} network path, in further embodiments, the process 700 may determine whether the latency threshold range of the medium latency group encompasses the latency attribute of the i^{th} network path (block 745). For example, the latency threshold range of the medium latency group may be defined by a second upper threshold limit and a second lower threshold limit. Thus, the process 700 may determine whether the latency attribute of the i^{th} network path is within the second upper threshold limit and the second lower threshold limit.

Thus, if the latency threshold range of the medium latency group encompasses the latency attribute of the i^{th} network path, in still more embodiments, the process 700 may classify the i^{th} network path into the medium latency group (block 750). Classifying the i^{th} network path into the medium latency group may correspond to including the i^{th} network path into a next hop group created for the medium latency category. After classifying the i^{th} network path into the medium latency group, the process 700 may again determine if all network paths have been classified into respective groups (block 735).

However, if the latency threshold range of the medium latency group does not encompass the latency attribute of the i^{th} network path, the latency attribute of the i^{th} network path may be determined to be within the latency range of the low latency group. In still further embodiments, the process 700 may classify the i^{th} network path into the low latency group (block 760). Classifying the i^{th} network path into the low latency group may correspond to including the i^{th} network path into a next hop group created for the low latency category After classifying the i^{th} network path into the low latency group, the process 700 may again determine if all network paths have been classified into respective groups (block 735).

Once the process 700 finishes classifying the two or more network paths into respective groups, in still additional embodiments, the process 700 may route an incoming traffic flow to the second network device via one of the plurality of groups (block 770). The choice of the group may depend on a latency requirements of the traffic flow. For example, latency-sensitive applications may be routed through network paths classified into the low latency group.

Pre-emptive classification of the two or more network paths into different groups based on their latency attributes may enable the process 700 to narrow its search to network paths in a specific group that is known to satisfy the latency requirements of a received traffic flow. By doing so, a computational overhead involved in path selection and load balancing is reduced. Moreover, classifying network paths based on latency attributes can facilitate scalability, enabling the process 700 to handle larger numbers of network paths without a proportional increase in complexity.

Although a specific embodiment for classification of network paths suitable for carrying out the various steps, processes, methods, and operations described herein is discussed with respect to FIG. 7, any of a variety of systems and/or processes may be utilized in accordance with embodiments of the disclosure. For example, the process 700 can also classify the two or more network paths into a plurality of groups based on other service attributes, such as bandwidth, reliability, or the like, in addition to the latency attributes. The elements depicted in FIG. 7 may also be interchangeable with other elements of FIGS. 1-6, 8, and 9 as required to realize a particularly desired embodiment.

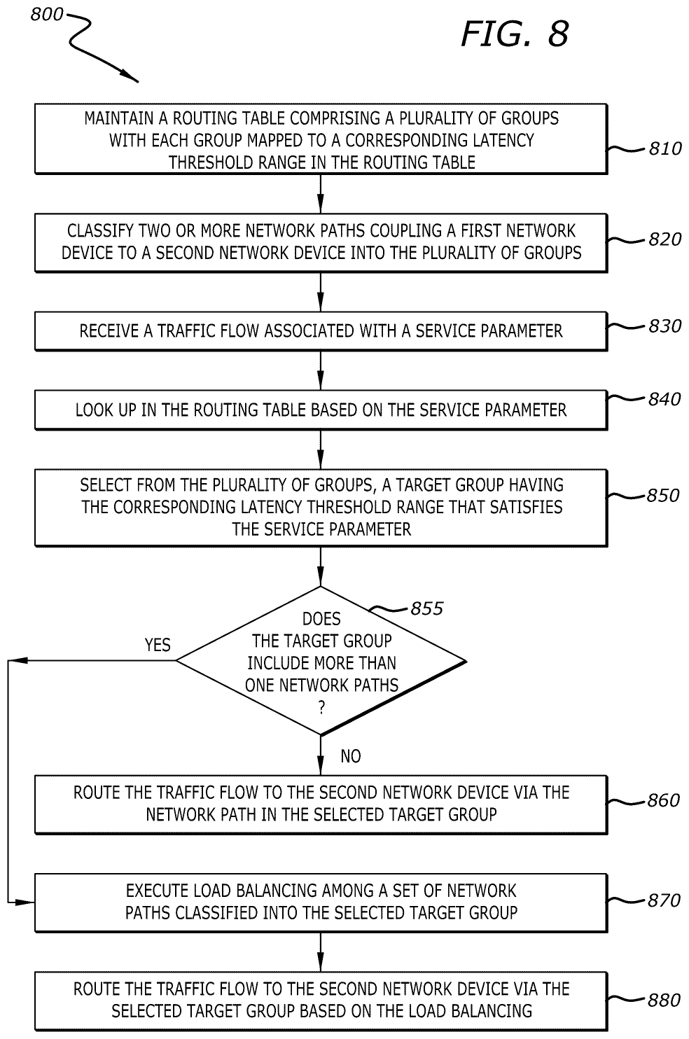

Referring to FIG. 8, a flowchart showing a process 800 for latency aware traffic routing in a network fabric in accordance with various embodiments of the disclosure is shown. In many embodiments, the process 800 may maintain a routing table comprising a plurality of groups with each group mapped to a corresponding latency threshold range in the routing table (block 810). The routing table may refer to a data structure stored in a switch or a network device for traffic routing. In more embodiments, the plurality of groups may include, for example, a low latency group, a medium latency group, and a high latency group. Thus, the routing table may include a first entry in which the low latency group is mapped to a first upper threshold limit and a first lower threshold limit. The first upper threshold limit and the first lower threshold limit may correspond to the upper and lower bounds, respectively, of the latency threshold range of the low latency group. Similarly, the routing table may include a second entry in which the medium latency group is mapped to a second upper threshold limit and a second lower threshold limit. The second upper threshold limit and the second lower threshold limit may correspond to the upper and lower bounds, respectively, of the latency threshold range of the medium latency group. Further, the routing table may include a third entry in which the high latency group is mapped to a third upper threshold limit and a third lower threshold limit. The third upper threshold limit and the third lower threshold limit may correspond to the upper and lower bounds, respectively, of the latency threshold range of the high latency group. The routing table can additionally include information such as destination network, subnet mask, next hop, interface, metric, and administrative distance. This routing table may be utilized to organize and classify network paths based on their latency attributes.

In a variety of embodiments, the process 800 may classify two or more network paths coupling a first network device to a second network device into the plurality of groups (block 820). In various embodiments, the first network device and the second network device may be leaf switches in a network fabric that are connected to each other through the two or more network paths. In an example, the network fabric can be a Disaggregated Scheduled Fabric. The two or more network paths can be classified into the plurality of groups based on latency attributes of the two or more network paths and the routing table. For example, if the process 800 encounters a network path with a latency attribute that falls within the first upper threshold limit and the first lower threshold limit included in the routing table, the process 800 may classify the network path into the low latency group. However, if the process 800 encounters a network path with a latency attribute that falls within the second upper threshold limit and the second lower threshold limit included in the routing table, the process 800 may classify the network path into the medium latency group. Further, if the process 800 encounters a network path with a latency attribute that falls within the third upper threshold limit and the third lower threshold limit included in the routing table, the process 800 may classify the network path into the high latency group.

In a number of embodiments, the process 800 may receive a traffic flow associated with a service parameter (block 830). The service parameter may be configured to indicate, for example, a latency requirement of the traffic flow. In numerous embodiments, the latency requirement may depend on an application generating the traffic flow. For example, real-time applications such as voice over IP (VOIP) or online gaming may have low latency requirements to ensure smooth and uninterrupted communication. Additionally, service-level agreements (SLAs) associated with the traffic flow can also indicate the latency requirement associated with the traffic flow. Moreover, various traffic classification mechanisms, such as Differentiated Services Code Point (DSCP) in an Internet Protocol (IP) header, can indicate the latency requirement of the traffic flow.

In several embodiments, the process 800 may look up in the routing table based on the service parameter (block 840). In other words, based on the service parameter of the received traffic flow, the process 800 may search the routing table to identify an entry that encompasses the service parameter.

In additional embodiments, the process 800 may select from the plurality of groups, a target group having the corresponding latency threshold range that satisfies the service parameter (block 850). In other words, the process 800 may look up in the routing table based on the service parameter (e.g., the low latency requirement) and select one of the plurality of groups as the target group having a corresponding latency threshold range that satisfies the service parameter. For example, based on the look up in the routing table, if the process 800 determines that the latency threshold range of the low latency group satisfies the service parameter of the received traffic flow, the process 800 may select the low latency group as the target group for routing the traffic flow.

In further embodiments, the process 800 may determine whether the target group includes more than one network path (block 855). If the target group includes only one network path, in still more embodiments, the process 800 may route the traffic flow to the second network device via the network path in the selected target group (block 860). In other words, the traffic flow is routed directly to the second network device via this single network path.

If, however, the target group includes more than one network path, in still additional embodiments, the process 800 may execute load balancing among a set of network paths classified into the selected target group (block 870). Load balancing may distribute the traffic across the set of network paths, ensuring that no single network path is overutilized while others in the same group remain underutilized. Examples of load balancing techniques may include, but are not limited to, ECMP routing, LACP routing, Adaptive Load Balancing, Source-Destination Hashing, Flow-based Load Balancing, Dynamic Load Balancing, weighted random load balancing, or the like.

In further additional embodiments, the process 800 may route the traffic flow to the second network device via the selected target group based on the load balancing (block 880). In other words, the traffic flow is routed to the second network device via at least one network path in the selected target group based on load balancing. Thus, ensuring efficient handling of the traffic, maintaining desired latency requirements, for example, for AI/ML workflows.

Although a specific embodiment for executing load balancing in a network fabric suitable for carrying out the various steps, processes, methods, and operations described herein is discussed with respect to FIG. 8, any of a variety of systems and/or processes may be utilized in accordance with embodiments of the disclosure. For example, the service parameter can be further configured to indicate other requirements such as transmission, reliability, or the like. In such scenarios, the process 800 may select the target group that satisfies the other requirement of the traffic flow. The elements depicted in FIG. 8 may also be interchangeable with other elements of FIGS. 1-7 and FIG. 9 as required to realize a particularly desired embodiment.

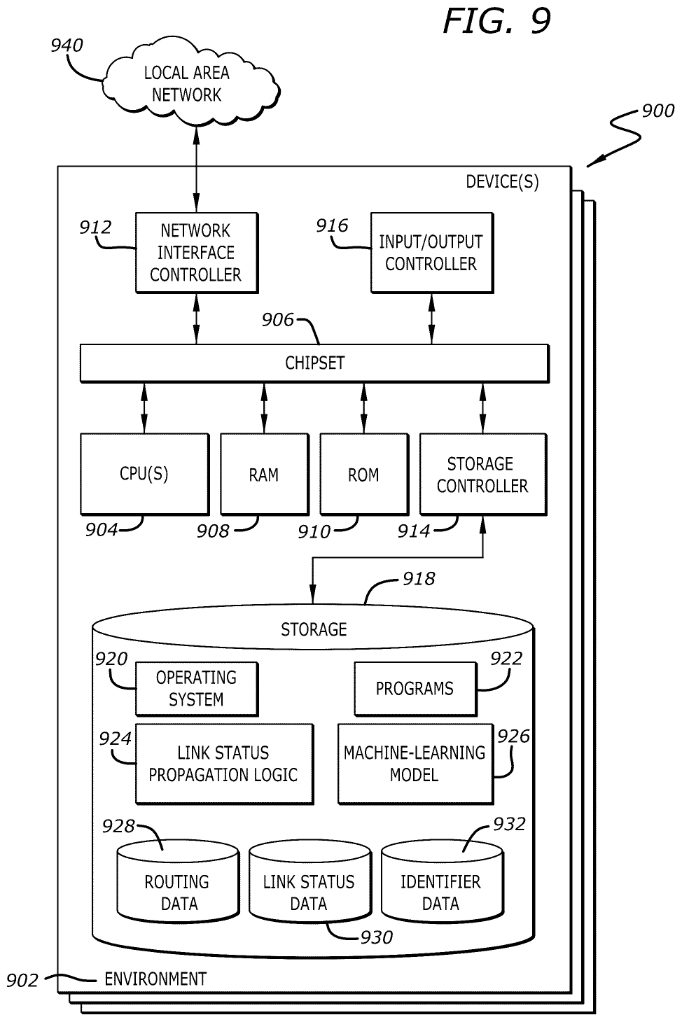

Referring to FIG. 9, a conceptual block diagram of a device 900 suitable for configuration with an assisted roaming logic, in accordance with various embodiments of the disclosure is shown. The embodiment of the conceptual block diagram depicted in FIG. 9 can illustrate a conventional server, switch, wireless LAN controller, access point, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, and applications 922. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In certain embodiments, the device 900 can also include computer-readable storage media having instructions stored thereupon for performing any of the other computer-implemented operations described herein.

In many further embodiments, the device 900 may include a routing logic 924. The routing logic 924 can be configured to perform one or more of the various steps, processes, operations, and/or other methods that are described above. Often, the routing logic 924 can be a set of instructions stored within a non-volatile memory that, when executed by the processor(s)/controller(s) 904 can carry out these steps, etc. In some embodiments, the routing logic 924 may be a client application that resides on a network-connected device, such as, but not limited to, a server, switch, personal or mobile computing device in a single or distributed arrangement.

In numerous embodiments, the routing logic 924 may classify two or more network paths in a network fabric (for example, a Disaggregated Scheduled Fabric) into a plurality of groups based on a latency attribute of each of the two or more network paths. Examples of the plurality of groups may include a low latency group, a medium latency group, a high latency group, or the like. The routing logic 924 may receive a traffic flow to be forwarded to a destination network device. In response to receiving the traffic flow, the routing logic 924 may identify one or more service attributes of the traffic flow. The one or more service attributes may be configured to indicate, for example, a latency requirement of the traffic flow. Thus, based on the identified service attribute, the routing logic 924 may select a target group, from the plurality of groups, that best satisfies the one or more service attributes. The routing logic 924 may then route the traffic flow to the destination network device via the selected target group, for example, via at least one network path classified into the target group. To route the traffic flow via the selected target group, the routing logic 924 may further execute load balancing among a set of network paths classified in the target group.

In numerous additional embodiments, the routing data 928 may comprise information used by network devices, such as leaf switches, spine switches, or the like to determine an optimal path for forwarding data packets to destination network devices. The routing data 928 may include routing tables, which include details about network paths, such as destination addresses, next-hop addresses, and associated metrics, for example, cost, distance, or latency. In an example, the routing data 928 may include a routing table in which each of the plurality of groups is associated with a corresponding latency threshold range. For example, the routing table may have a first entry in which the low latency group is mapped to a first upper threshold limit and a first lower threshold limit. The first upper threshold limit and the first lower threshold limit may correspond to the upper and lower bounds, respectively, of the latency threshold range of the low latency group. Similarly, the routing table may have a second entry in which the medium latency group is mapped to a second upper threshold limit and a second lower threshold limit. Further, the routing table may have a third entry in which the high latency group is mapped to a third upper threshold limit and a third lower threshold limit. Thus, if the routing logic 924 encounters a network path with a latency attribute that falls within the first upper threshold limit and the first lower threshold limit included in the routing table, the routing logic 924 may classify the network path into the low latency group.

In various embodiments, the latency attribute data 930 can comprise specific information related to delay experienced as data packets travel from one point in a network to another. The latency attribute data 930 may include, for example, propagation delay data, transmission delay data, processing delay data, queuing delay, or the like. In an example, the latency attribute data 930 may include information regarding latency attribute of various network paths connected to the device 900.

In a number of embodiments, latency threshold data 932 may comprise information regarding predefined upper and lower latency limits associated with each of the plurality of groups. The latency threshold data 932 may further include latency-based application categories, for example, low latency based real-time applications, medium latency based applications such as streaming video, and high latency based applications such as file transfers, or the like. By comparing the latency attributes of network paths against the latency threshold data 932, the routing logic 924 can classify the network paths into the plurality of groups.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform the functions described herein. The virtualization layer may generally support a virtual resource that performs at least a portion of the techniques described herein.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926. The ML model 926 may be configured to predict latency attributes of various network paths connected to the device 900 based on characteristics of routed traffic. For example, the ML model 926 may be configured to predict latency attributes of a network path based on a round trip time associated with the network path.

The ML model(s) 926 can be configured to generate inferences to make predictions or draw conclusions from data. An inference can be considered the output of a process of applying a model to new data. This can occur by learning from at least the routing data 928, the latency attribute data 930, and the latency threshold data 932. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although a specific embodiment for a device suitable for configuration with the assisted roaming logic for carrying out the various steps, processes, methods, and operations described herein is discussed with respect to FIG. 9, any of a variety of systems and/or processes may be utilized in accordance with embodiments of the disclosure. For example, the device 900 may be in a virtual environment such as a cloud-based network administration suite, or it may be distributed across a variety of network devices. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a transceiver, wherein the device is coupled to a network device via two or more network paths and each network path of the two or more network paths is associated with a latency attribute; and
a memory communicatively coupled to the processor, wherein the memory comprises a routing logic that is configured to:
classify the two or more network paths into a plurality of groups based on the latency attribute of each of the two or more network paths;
receive a traffic flow for the network device;
select from the plurality of groups, a target group in response to receiving the traffic flow; and
route the traffic flow to the network device via the selected target group.

2. The device of claim 1, wherein the plurality of groups comprises at least a low latency group and a high latency group.

3. The device of claim 2, wherein the low latency group has lower transmission latency than the high latency group.

4. The device of claim 2, wherein the plurality of groups further comprises a medium latency group.

5. The device of claim 4, wherein the medium latency group has lower transmission latency than the high latency group and higher transmission latency than the low latency group.

6. The device of claim 1, wherein each group of the plurality of groups is associated with a latency threshold range.

7. The device of claim 6, wherein to classify the two or more network paths into the plurality of groups, the routing logic is further configured to:
compare the latency attribute of each of the two or more network paths with the latency threshold range of each of the plurality of groups, wherein the routing logic classifies a network path of the two or more network paths into one of the plurality of groups that is associated with the latency threshold range encompassing the latency attribute of the network path.

8. The device of claim 1, wherein the traffic flow is associated with a service parameter.

9. The device of claim 8, wherein the routing logic selects, from the plurality of groups, the target group that satisfies the service parameter.

10. The device of claim 9, wherein the service parameter is configured to indicate a latency requirement associated with the traffic flow.

11. The device of claim 8, wherein the routing logic is further configured to maintain a routing table comprising the plurality of groups, each group of the plurality of groups being mapped to a corresponding latency threshold range in the routing table.

12. The device of claim 11, wherein the routing logic is further configured to look up in the routing table based on the service parameter, and wherein the routing logic selects from the plurality of groups, the target group having the corresponding latency threshold range that satisfies the service parameter.

13. The device of claim 1, wherein each of the plurality of groups comprises a set of network paths, of the two or more network paths, classified into corresponding group.

14. The device of claim 13, wherein to route the traffic flow via the target group, the routing logic is further configured to execute load balancing among the set of network paths classified into the target group.

15. The device of claim 1, wherein the device is a leaf switch in a disaggregated scheduled fabric.

16. The device of claim 1, wherein the traffic flow is associated with an AI/ML workflow.

17. The device of claim 1, wherein prior to classifying the two or more network paths, the routing logic is further configured to determine the latency attribute associated with each of the two or more network paths.

18. A device, comprising:
a processor;
a transceiver, wherein the device is coupled to a network device via two or more network paths and each network path of the two or more network paths is associated with one or more service attributes; and
a memory communicatively coupled to the processor, wherein the memory comprises a routing logic that is configured to:
classify the two or more network paths into a plurality of groups based on at least one of the one or more service attributes;
receive a traffic flow for the network device;
select from the plurality of groups, a target group in response to receiving the traffic flow; and
route the traffic flow to the network device via the selected target group.

19. The device of claim 18, wherein prior to classifying the two or more network paths, the routing logic is further configured to determine the one or more service attributes associated with each of the two or more network paths.

20. A routing method, comprising:
classifying two or more network paths into a plurality of groups based on a latency attribute associated with each of the two or more network paths, wherein a first network device and a second network device are communicatively coupled via the two or more network paths;
receiving a traffic flow at the first network device;
selecting from the plurality of groups, a target group in response to receiving the traffic flow; and
routing the traffic flow received at the first network device to the second network device via the selected target group.
